(19) United States
(12) Patent Application Publication
(10) Pub. No.: US 2012/0226725 A1
(43) Pub. Date: Sep. 6, 2012

(54) METHOD AND SYSTEM FOR GENERATING RANDOM NUMBERS

(76) Inventor: Chang Keun Yang, Seongnam-si (KR)

(21) Appl. No.: 13/508,365

(22) PCT Filed: Nov. 3, 2010
(86) PCT No.: PCT/KR10/07716

§ 371 Date: May 5, 2012

(30) Foreign Application Priority Data
Nov. 6, 2009 (KR) 10-2009-0107183

(51) Int. Cl. G06F 7/58

(52) U.S. Cl. 708/250

(57) ABSTRACT

The present invention relates to a method and system for generating random numbers. The method for generating random numbers comprises the following steps: (a) generating a plurality of first random number samples; (b) assigning relative priority values to each of the first random number samples, wherein a common difference exists between neighboring priority values when the relative priority values are sorted in an ascending order or in a descending order; and (c) converting the first random number samples into respective second random number samples on the basis of the relative priority values. According to the present invention, the second random number samples are those converted into mathematical expectations which can be generated from the relative priority values. The method and system of the present invention can generate a plurality of random number samples having a distribution that is closest to the theoretical mean value and variance value, or having a uniform distribution.

### FIELD OF THE INVENTION

This invention relates to random number generation and its system. More specifically, it relates to a method and its system of generating random numbers which gives ranking values of random numbers of a first random number set, converts the first random number set to a second random number set whose mean value and variance value are consistent and are equal to or very close to those of theory.

### DESCRIPTION OF THE RELATED ART

With the development of information and communication technology, encryption and decoding technology is regarded as very important to keep information secure. Especially, random numbers are used effectively in various areas including for secret keys of security systems. For example, in a system where security is important, modules generating random numbers can be equipped with modules that generate random numbers whose values are unpredictable.

And, in generating random numbers, a plural number of generated random numbers (also known as random number set) can be required to have specific mean, variance, and distribution in research like statistical analysis.

For example, in doing operation research to get the most effective system for problems such as company strategy and inventory management, etc, random number based simulation is used to provide realistic modeling. In this case, to get a highly reliable simulation results, generated random number sets are required to be independently and uniformly distributed.

Some discussions about existing methods of generating random numbers seem to be proper. There are two methods of generating random numbers: a method using hardware, and a method using software. For the former, there are ways of generating random numbers, e.g. using heat noise of resistant material, decay of radioactive material, or others. The latter method will be discussed more in detail below.

First, let us discuss the existing method of generating random numbers with continuous distribution. With the existing method of generating random numbers with continuous distribution (for example, standard normal distribution), there can be a method of using the RAND function, and then using NORMSINV function of the Excel program.

Specifically, the RAND function generates random numbers from 0 to 1. The random number generating module using the RAND function is realized by automatically extracting and supplying random numbers within the range from 0 to 1. By using RAND function multiple times, one can easily get a plural number of random numbers continuously distributed from 0 to 1.

On the other hand, the NORMSINV function returns the inverse values of standard normal cumulative distribution. By entering cumulative probability values, the module automatically provides the inverse function values corresponding to the cumulative probability values, which are equivalent to Z scores of standard normal distribution.

To generate random numbers following standard normal distribution, a user first generates a set of random numbers within the range from 0 to 1 by using the RAND function. Then, the user, by using the NORMSINV function, can convert this set of random numbers into new random numbers set following standard normal distribution.

The theoretical mean and variance of standard normal distribution should be 0 and 1. However, there has been a problem that the set of random numbers generated has a finite number of random numbers, its distribution does not perfectly replicate theoretical distribution, and its mean and variance deviate from theoretical values. Accordingly, statistical analyses based on these random number sets can potentially have simulation errors.

In addition, because of the characteristics of a random number generator like the RAND function, whenever a new random number is generated, the mean and variance of the random number set change. Therefore, it is difficult to acquire a random number set with consistent mean and variance.

Second, there can be cases where a random number set follows discontinuous distribution. For example, one can convert a random number set generated by the RAND function to a set of grades (e.g., if the range from 0 to 1 is divided into 10 sections, a random number belonging to the section between 0.9 and 1.0 becomes grade 1, and random number belonging to the section between 0.8 and 0.9 becomes grade 2, and so on).

However, the random number set generated by the RAND function is not uniformly distributed and the number of simulation cases belonging to each grade deviates from the theoretical number. Such a problem can cause unintended simulation errors in the statistical analysis and cannot be completely resolved simply by increasing the number of random numbers. Therefore, a solution to this problem is required.

### DETAILED DESCRIPTION OF THE INVENTION

### Objects of Invention

This invention is designed to resolve all of the problems of existing methods of random number generation. This invention changes a random number set generated by an existing random number generator into new random number set with a consistent distribution. This invention makes the new random number set have a consistent mean and variance.

In addition, this invention makes the distribution of the new random number set become equal to, or very close to theoretical distribution. (e.g., the mean and variance of the new random number set following continuous probability distribution are made to have values equal to, or close to the theoretical values. Or the mean and variance of the new random number set following discontinuous probability distribution are made to have values equal to or very close to the theoretical values.)

### Method to Achieve Objects

To achieve the above objects, this invention includes following methods. This invention provides a method for generating random numbers including following steps: (a) a step of generating the first random number set; (b) a step of assigning a ranking value to each random number of the set—If the first random number set is sorted by the ranking values in ascending order or descending order, neighboring ranking values have a common difference; (c) a step in which, based on the relative ranking value assigned to the each random number of the first random number set, each random number of the first random number set is converted into the second random number set.

This invention also provides a method for generating random numbers including following steps: (a) M number of relative ranking values are generated; (b) Based on the relative ranking values, a random number set composed of M number of random numbers is generated; (c) a random number set is generated using the M number of random numbers as population. The common difference of relative ranking values is k, where the minimum of relative ranking value is 0 or 0+k, and the maximum of relative ranking value is 1 or 1−k.

This invention also provides a system for generating random numbers including following modules (a) a module for generating a first random number set;

(b) a module for assigning ranking value to each random number of the set—If the first random number set is sorted by the ranking values in ascending order or descending order, neighboring ranking values have a common difference; (c) a module in which, based on the relative ranking value assigned to the each random number of the first random number set, each random number of the first random number set is converted into a second random number set.

### The Effects of the Invention

The effects of this invention are as follows: (1) It is possible to generate a random number set whose distribution is consistent; (2) It is possible to generate a random number set whose mean and variance is consistent; (3) It is possible to generate a random number set whose distribution is equal to, or very close to theoretical distribution.

### BRIEF DESCRIPTION OF THE DRAWINGS

FIG. 1 shows a system for generating random numbers following Embodiment 1.

FIG. 2 shows the process of generating the second random number set with standard normal distribution following Embodiment 1.

FIG. 3 shows the process of generating the second random number set with discontinuous distribution following Embodiment 1.

FIG. 4 shows a system for generating random numbers following Embodiment 2.

### DESCRIPTION OF MAJOR MODULES OF DRAWINGS

110: User input module

120: The first random number set generating module

130: Ranking value assigning module

140: The second random number set conversion module

150: Output module

160: Communication module

170: Control module

### Embodiment 1

Below is the detailed explanation of embodiments in which this invention is applied, referring to drawings.

### Overview of the Whole System

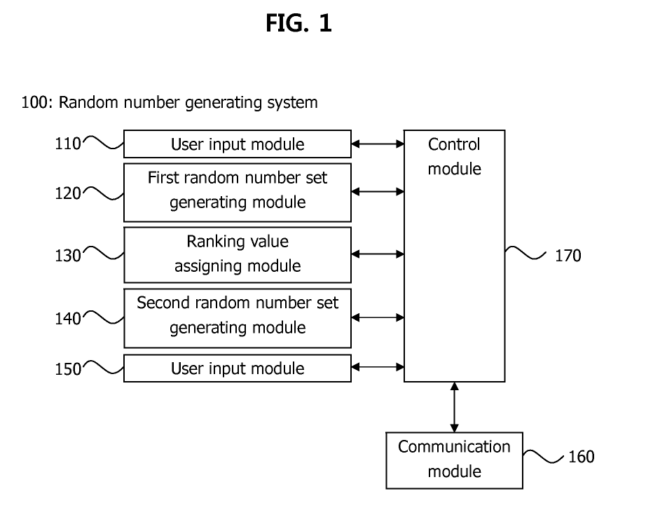

FIG. 1 shows a system 100 for generating random numbers following Embodiment 1. As shown in FIG. 1, the system 100 consists of the following modules: a user input module 110, a first random number set generating module 120, a ranking value assigning module 130, a second random number set conversion module 140, an output module 150, a communication module 160, and a control module 170.

In Embodiment 1, among the user input module 110, the first random number set generating module 120, the ranking value assigning module 130, the second random number set conversion module 140, the output module 150, at least some can be program modules. Such modules can be included in the user terminal unit in the form of operating system, applied program module, or other program module. Physically, they can be stored on various storage units. Such program modules include routine, subroutine, program, object, component, data structure, and etc which can perform specific processes described below, but not limited to them.

First, the user input module 110 receives all the information regarding the number of random numbers, mean, variance, and distribution of the second random number set that a user ultimately wants to generate. The user input module 110 can provide a user interface allowing the user to input the above information via computer keyboard or mouse.

Next, the first random number set generating module 120 performs the function of generating multiple random numbers. While the first random number set generating module 120 can generate as many as the number of random numbers input through the user input module 110, it is not necessarily limited to it. For example, to the extent that a default number of random numbers are allowed to be generated. Here, the first random number set generated by the first random number set generating module 120 can be made to have arbitrary value distribution. But, it can also be made to have the same distribution as the specific continuous probability distribution of the second random number set the user ultimately tries to generate. Specifically, the first random number set generating module can be any format of random number generator (hardware-based or software-based) as long as it can generate a set of random numbers. For example, not only the means of generating random numbers using natural physical phenomena (e.g., heat noise of resistant material or decay of radioactive material), but also the means of generating random numbers using logic circuit (e.g., flip-flop circuit) and software can also be applied as the first random number set generating module 120.

Next, the ranking value assigning module 130 assigns ranking values to the random numbers of the first random number set. Since those ranking values are relative ranking in the set, they can be unique for each random number (i.e., mutually different). Those ranking values can be values expressed as percentile ranks or thousandth ranks. The algorithm used for assigning relative ranking values is explained in the “Ranking value assigning module” below.

Next, the second random number set conversion module 140 treats relative ranking values as cumulative probability values, and generates variable values from theoretical probability distribution corresponding to the above cumulative probability values, which are relative ranking values. Through this procedure, the first random number set is converted into the second random number set.

The second random number set conversion module 140 can convert the second random number set into either one with continuous probability distribution or one with discontinuous probability distribution. Which kind of probability distribution the second random number set would follow can be specified by inputs via the user input module 110, or a set-up of the operation of the second random number set conversion module 140.

If the random number set conversion module 140 converts the first random number set into the second random number set with continuous probability distribution, relative ranking values assigned to the first random number set are considered as cumulative probability values, and the second random number set can be calibrated from corresponding cumulative probability values based on theoretical continuous probability distribution, for example by using an inverse function of a specific continuous probability distribution. The specific continuous probability distribution can be normal distribution and as described above can be specified by the user input module 110, but it is not limited to that. It can be standard normal distribution, Beta distribution, Chi distribution, F distribution, Gamma distribution, Log distribution, or T distribution, etc.

If the random number set conversion module 140 converts the first random number set into a second random number set with discontinuous probability distribution, one should discern in which discontinuous section (e.g., the range where random numbers belong to is divided into n sections) relative ranking values assigned to the first random number set belong to, and set each section value as the second random number value. In the same manner, though the specific discontinuous probability distribution can be specified by the user input module 110, it is not limited to that.

Next, the output module 150 performs the output function of the second random number set acquired from the above method. The output module 150 can be made to display the second random number set using the output unit of a computer monitor.

Next, the communication module 160 enables the random number generating system 100 to communicate with external units such as the user terminal, etc.

Finally, the control module 170 controls data flows among the user input module 110, the first random number set generating module 120, the ranking value assigning module 130, the second random number set conversion module 140, the output module 150, and the communication module 160. That is, the control module 170, by controlling data flows among multiple modules of the random number generating system 100, lets the user input module 110, the first random number set generating module 120, the ranking value assigning module 130, the second random number set conversion module 140, the output module 150, and the communication module 160 perform their unique and designated functions.

### Assigning Ranking Values

The algorithm giving relative ranking values is described below. When relative ranking values assigned to random numbers of the first random number set are sorted in ascending order or descending order, there can be common difference between neighboring ranking values.

Such common difference can be determined by referring to the number of random numbers inputs via the user input module 110 to generate the second random number set. For example, if the number of random numbers in the second random number set is 1,000 (and, assuming that either the maximum value or minimum value is not decided), one can assign relative ranking values in the first random number set with the common difference of 1/1,000.

Specifically, assuming there are M random numbers in the first random number set and the set is sorted in ascending order, a number from 1 to M can be assigned to each random numbers in sequential order (i.e., 1 is assigned to the lowest random number, and M is assigned to the highest random number). In this case, a specific relative ranking value assigned to each random number in the first random number set can be one of the following three formulas—the number assigned to the random number/(M+1), the number assigned to the random number/M, or the number assigned to the random number/(M−1). The choice of one of the above three formulas depends on whether the real maximum or minimum value of the second random number set is known or not. If the maximum and minimum values of the second random number set are not decided, the number assigned to the random number/(M+1) can be given. The decision of whether the maximum and minimum values of the second random number set will be specified or not can be specified by inputs via the user input module 110, or operational setting-up of the second random number set conversion module 140.

On the other hand, each of relative ranking values assigned to random numbers of the first random number set can be considered as cumulative probability in the probability distribution of the second random number set. The cumulative probability represents a probability that, where an arbitrary random number sample has a certain ranking value (for example, magnitude), random number samples with a value less than or equal to the certain ranking value will be generated. Since minimum and maximum values of any cumulative probability are 0 and 1 respectively, relative ranking values are equal to or higher than 0, and are equal to or lower than 1.

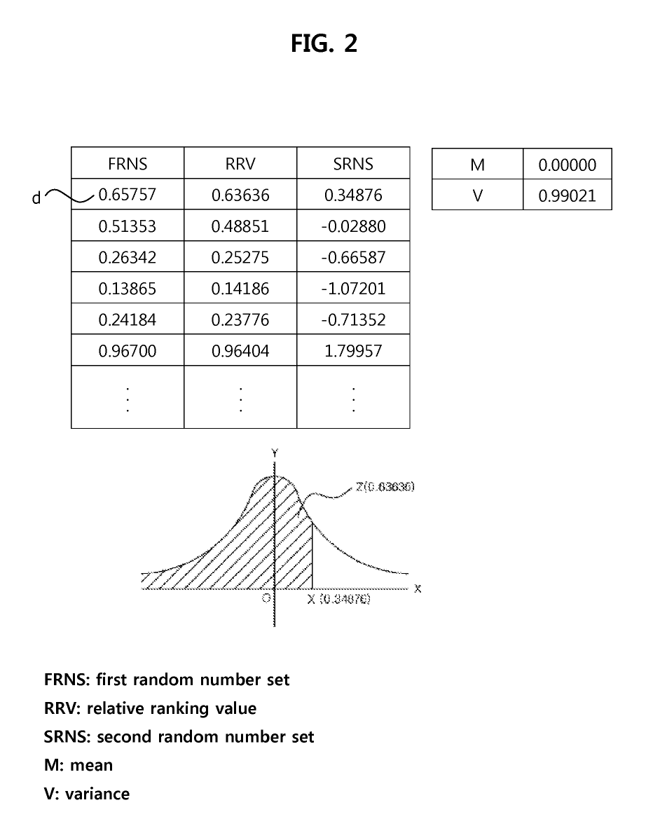

An illustration of assigning relative ranking values referring to FIG. 2 is as follows. First, let's assume that the number of random numbers of the second random number set that the user ultimately wants to generate is 1,000, and 1,000 random numbers are generated in the first random number set. As described above, the common difference for 1,000 random numbers can be either 1/999, 1/1000, or 1/1001. Assuming the real maximum and minimum values of the second random number set are not known, referring to FIG. 2, the common difference for the first random number set is 1/1001.

Afterwards, all the random numbers of the first random number set are sorted in ascending order, and then numbers from 1 to 1,000 will be assigned to the each random number set from the lowest to the highest. Even though it is not shown in the FIG. 2, random number d is the 627^{th} lowest random number in the first random number set and 637 is assigned.

Accordingly, 0.63636 [=637 (the number assigned to random number d of the first random number set)×1/1001 (common difference)] is the relative ranking value for random number d. When this procedure is repeated over and over again for the all random numbers of the first random number set, we get the results illustrated in FIG. 2.

Case with Continuous Distribution

Below is the process of generating a random number set with standard normal distribution, referring to FIG. 2. FIG. 2 shows the process of generating the second random number set with standard normal distribution.

First, a user can input the number of random numbers which will be generated via the user input module 110.

Next, the first random number set generating module 120 performs the function of generating the first random number set by a certain function. The function can use the time or order as variable. Thus, the first random number set generating module 120 generates the first random number set composed of plural number of random numbers following the time or order. As described above, it is desirable for the first random number set generating module 120 to generate random numbers as many as the number specified via the user input module 110.

Next, the ranking value assigning module 130 assigns a relative ranking value to each of the random numbers of the first random number set. Referring to FIG. 2, (a) a relative ranking value is assigned to each random number of the first random number set, (b) the differences between neighboring ranking values can be made equal when assorted by the relative ranking values in ascending order or descending order, and (c) such relative ranking values are considered as cumulative probability of the probability distribution of the second random number set.

Next, assuming that the second random number set follows the standard normal distribution, the second random number set conversion module 140 can take relative ranking values of the first random number set as the cumulative probability of standard normal distribution, and calibrate the second random number set from corresponding cumulative probability values (assigned to the first random number set) based on theoretical standard normal distribution, for example by using inverse function of a standard normal distribution probability distribution. Assuming that the relative ranking value 0.63636 of random number d of the first random number set is the cumulative probability (Z) in the standard normal distribution, one can calibrate the value X=0.34876 (where X=NORMSINV(0.63636)) as the random number for the second random number set, referring to FIG. 2.

The second random number set generated by such a method has mean value and variance value equal or close to theoretical values of standard normal distribution, which are 0 and 1 respectively.

Case with Discontinuous Distribution

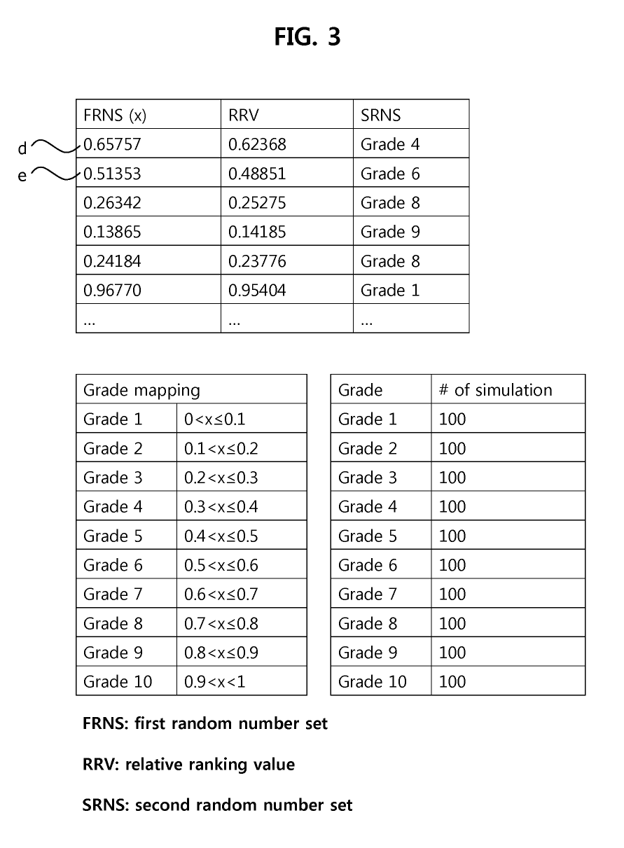

Referring to FIG. 3, let us describe the process of generating random numbers with discontinuous distribution. FIG. 3 shows the process of generating the second random number set with discontinuous distribution.

First, through the same and similar method of the previous case, one can generate the first random number set, and assign a relative ranking value to each random number of the first random number set.

Next, the second random number conversion module 140 converts the first random number set into the second random number set by discerning which section of the second random number set each relative ranking value of the first random number set belongs to, and setting it as the value of the second random number set. For example, in FIG. 3, since the ranking value of random number d of the first random number set belongs to the 0.6-0.7 section, random number d can be converted into grade 4 (value of the corresponding section) in the second random number set. In the same manner, since the ranking value of the random number e of the first random number set belongs to 0.4-0.5 section, random number e of the first random number set can be converted into grade 6 (value of the corresponding section) in the second random number set.

The second random number set generated by such a method follows a distribution equal to or close to the theoretical distribution.

### Embodiment 2

Components and their functions of the random number generating system 400 following Embodiment 2 of this invention will be described below.

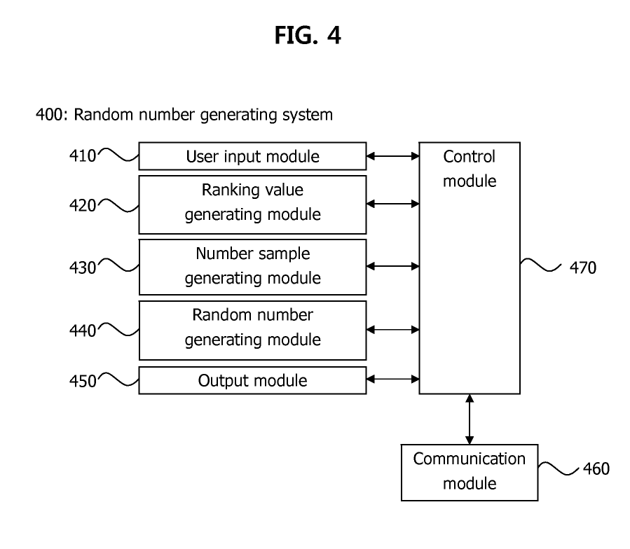

FIG. 4 shows detailed modules of the random number generating system 400, following Embodiment 2. In FIG. 4, the random number generating system 400 includes a user input module 410, a ranking value generating module 420, a number sample generating module 430, a random number generating module 440, an output module 450, a communication module 460, and a control module 470.

Since the functions of the user input module 410, the output module 450, the communication module 460, and the control module 470 are the same and can function by the same units described in previous Embodiment 1, further description of them will be omitted here.

Next, the ranking value generating module 420 can generate M number of relative ranking values. Here, the ranking value generating module 420 can be made to generate M number of ranking values with a common difference k with the minimum value being 0 or 0+k and the maximum value being 1 or 1−k. Whether the minimum value of the ranking value is 0 or 0+k relies on whether the real minimum value of the second random number set is known or not. In the same manner, whether the maximum value of the ranking value is 0 or 0+k relies on whether the real maximum value of the second random number set is known or not. For example, if the real minimum and maximum values of the second random number set are not known, the minimum value of the ranking value is 0+k, and its maximum value is 1−k.

In addition, it is desirable for the common difference k to be decided based on the number of ranking values (M). For instance, if the real minimum and maximum values of the second random number set are not known, the common difference k can be 1/M+1.

Next, the number sample generating module 430 can serve the function of forming a number sample group consisting of M number of numbers based on the above relative ranking values. The number sample generating module 430 can function similarly with the second random number set generating module 140 of Embodiment 1. That is, the number sample generating module 430 considers relative ranking values as cumulative probability, calibrates variable values corresponding to the cumulative probability, and generates a set of numbers. In addition, the number sample generating module 430 can generate a set of numbers either with continuous probability distribution or with discontinuous distribution.

Next, the random number generating module 440 generates random numbers using the above M number of random numbers as population. To do this, the random number generating module 440 can generate more than one random number set by random order among the population.

This invention described above can be embodied in the form of computer program commands executed through various computer components, and can be recorded in recording media decipherable through computer. Computer-decipherable recording media include program commands, data file, and data structure respectively and jointly. Program commands used in the above recording media can be either what is specially designed for this invention or what is well-known and available in the industry. Computer-decipherable recording media include magnetic media such as hard disk, floppy disk and magnetic tape, optical media such as CD-ROM and DVD, magneto-to-optical media like floptical disk, and hardware units specifically constituted to store and execute program commands such as ROM, RAM, and flash memory. Program commands include high-quality language codes which can be executed by computer using something like interpreter as well as machine codes like what are made by compilers. The above hardware units can be constituted to be operated with more than one module to execute the processes and steps described in this invention, and vice versa.

Although specific terms are employed herein, they are used in a generic and descriptive sense only and not for purposes of limitation, it is provided only to help readers understand this invention. This invention is not limited to such descriptions, and those who have common knowledge in the fields related with this invention can come up with many modifications and other embodiments of this invention in various ways.

Therefore, it is to be understood that the inventions are not to be limited to the specific examples of the embodiments disclosed and that modifications and other embodiments are intended to be included within the scope of the claims.

What is claimed is:

1. A method for generating random numbers, the method comprising the steps of (a) generating a first random number set; (b) assigning a ranking value to each random number of the set such that if the first random number set is sorted by the ranking values in ascending order or descending order, neighboring ranking values have common difference; and (c) converting each random number of the first random number set into a second random number set, based on the relative ranking value assigned to the each random number of the first random number set.

2. The method according to claim 1, wherein the first random number set follows a specific continuous probability distribution.

3. The method according to claim 2, wherein the second random number set follows a specific continuous probability distribution.

4. The method according to claim 3, wherein the first random number set is converted into the second random number set in the step (c) based on user-specified inputs which can define the distribution of the second random number set.

5. The method according to claim 3, wherein the specific continuous probability distribution is one of the following probability distributions—normal distribution, standard normal distribution, Beta distribution, Chi distribution, F distribution, Gamma distribution, Log distribution, or T distribution.

6. The method according to claim 1, wherein the second random number set follows discontinuous probability distribution.

7. The method according to claim 6, wherein the second random number set is obtained by discerning to which section of the second random number set a cumulative probability belongs.

8. The method according to claim 1, wherein the relative ranking values in the step (b) are cumulative probabilities of the probability distribution of the second random number set.

9. The method according to claim 1, wherein the common difference in the step (b) is calculated based on the number of random numbers of the second random number set.

10. The method according to claim 1, wherein the first random number set has M random numbers, the M random numbers are sorted in ascending order, numbers from 1 to M are assigned to each random number in sequential order, and a relative ranking value assigned to each random number in the first random number set can be one of the following values—the number assigned to the random number/(M+1), the number assigned to the random number/M, (the number assigned to the random number−1)/M, or the number assigned to the random number/(M−1).

11. A method for generating random numbers, the method comprising (a) a step to generate M number of relative ranking values; (b) a step to generate a random number set composed of M number of random numbers based on the above relative ranking values; and (c) a step to generate a random number set using the above M number of random numbers as population wherein the common difference of relative ranking values is k, the minimum of relative ranking value is 0 or 0+k, and the maximum of relative ranking value is 1 or 1−k.

12. A system for generating random numbers, the system comprising modules for (a) generating a first random number set; (b) assigning ranking value to each random number of the set such that if the first random number set is sorted by the ranking values in ascending order or descending order, neighboring ranking values have common difference; and (c) converting each random number of the first random number set into a second random number set, based on the relative ranking value assigned to the each random number of the first random number set.

13. The system according to claim 12, wherein the relative ranking values are cumulative probabilities of the probability distribution of the second random number set.

14. The system according to claim 12, wherein the second random number set follows a specific continuous probability distribution.

15. The system according to claim 14, wherein the first random number set follows a specific continuous probability distribution.

16. The system according to claim 14, wherein the specific continuous probability distribution is one of the following probability distributions—normal distribution, standard normal distribution, Beta distribution, Chi distribution, F distribution, Gamma distribution, Log distribution, or T distribution.

17. The system according to claim 12, wherein the second random number set follows discontinuous probability distribution.

18. The system according to claim 17, wherein the second random number set is obtained by discerning to which section of the second random number set a cumulative probability belongs.

19. The system according to claim 12, further comprising a user input module accepting user-specified inputs on the number, the mean or variance value, or the distribution of the second random number set.

20. The system according to claim 12, wherein the first random number set has M random numbers, the M numbers are sorted in ascending order, numbers from 1 to M are assigned to each random number in sequential order, and the module for assigning ranking value assigns one of the following three values—the number assigned to the random number/(M+1), the number assigned to the random number/M, or the number assigned to the random number/(M−1)—as the relative ranking value.

21. Computer-decipherable recording media which record computer programs to execute the method according to claim 1.
